(19) United States
(12) Patent Application Publication
(10) Pub. No.: US 2026/0205819 A1
(43) Pub. Date: Jul. 16, 2026

(54) ILLEGAL DEVICE DETECTION AND BLOCKING APPARATUS

(71) Applicant: INNERTRON, INC., Incheon (KR)

(72) Inventors: Hak Rae CHO, Incheon (KR); Soo Duk SEO, Incheon (KR); Youn Cheul CHA, Yongin-si, Gyeonggi-do (KR)

(73) Assignee: INNERTRON, INC., Incheon (KR)

(21) Appl. No.: 19/138,184

(22) PCT Filed: Nov. 27, 2023
(86) PCT No.: PCT/KR2023/019252

§ 371 Date: Jun. 12, 2025

(30) Foreign Application Priority Data
Dec. 13, 2022 (KR) 10-2022-0173601

(51) Int. Cl. H04W 12/122; H04W 84/12

(52) U.S. Cl. CPC H04W 12/122; H04W 84/12

(57) ABSTRACT

An illegal device detection and blocking apparatus includes a network connection unit configured to connect to the wireless LAN of a monitored network; a storage unit configured to store a MAC list; a control unit configured to receive MAC addresses of devices connected to the network via the network connection unit, and to block data transmission when an illegal MAC address is detected; and a wireless communication unit configured to transmit and receive signals between the control unit and a user terminal.

### TECHNICAL FIELD

The present invention relates to a system for detecting unauthorized illegal devices such as illegal cameras, and more particularly, to an illegal device detection and blocking apparatus for a wireless network that monitors devices on the wireless network and blocks any unauthorized devices upon detection, as well as to a detection and blocking system comprising the same.

### BACKGROUND

Recently, security issues have been emerging where spy chips are maliciously embedded in computer peripherals to create wired or wireless backdoors, allowing the theft of classified national information, corporate technical and business data, and personal information. In addition, the installation of illegal cameras for covert recording, which invades personal privacy and leads to the distribution of illegal footage, has become a serious social problem.

A conventional technology for preventing such illegal activities is disclosed in Korean Patent Publication No. 10-2021-0009917, titled “AI Algorithm-Based Real-Time Blocking and Alarm Device for Illegal Hidden Cameras,” published by the Korean Intellectual Property Office. This published patent discloses a prediction unit applying a Hidden Markov Model (HMM), which performs prediction using a state transition probability matrix (A), an emission probability (B), and an initial state probability vector (z). It further discloses an illegal device blocking unit that blocks illegal hidden cameras in real time by analyzing network traffic and device load based on current consumption, and an illegal video determination unit that confirms illegal videos through packet analysis.

In addition, Korean Patent Publication No. 10-2014-0071776, titled “Method and System for Detecting Wireless LAN Intrusion,” discloses a technique in which an intrusion detection sensor detects packets suspected of attacks originating from either external or internal sources, and an intrusion detection access point (AP) manages AP generation frames generated from all APs in the wireless LAN. A threat management server extracts frames contained in the suspected attack packets and determines whether the extracted frames match any AP generation frames, thereby identifying whether the packets are part of an attack.

### DISCLOSURE OF THE INVENTION

### Technical Goals

The conventional illegal hidden camera blocking devices and wireless LAN intrusion detection technologies have the drawback that they cannot detect and block illegal devices in advance, as they rely on monitoring transmission packets of recorded videos to detect illegal content or inspecting frames included in the transmission packets.

The present invention has been proposed to solve the above-mentioned problems, and an object of the invention is to provide an illegal device detection and blocking apparatus that monitors device information on a wireless network, detects unauthorized illegal devices, and blocks such devices in advance before any illegal activity occurs.

In addition, another object of the present invention is to provide a portable illegal device detection and blocking apparatus that allows individual users to conveniently detect and block illegal devices in any location.

### Technical Solutions

According to an embodiment of the present invention, the illegal device detection and blocking apparatus is configured to detect and block illegal devices such as hidden cameras that may be installed on a monitored network. The apparatus comprises: a network connection unit connected to the wireless LAN of the monitored network; a storage unit for storing a MAC address list (MAC list); and a control unit that receives the MAC addresses of devices connected to the network through the network connection unit, and blocks data transmission from a device if an unauthorized MAC address is detected; The apparatus further includes: a wireless communication unit for transmitting and receiving signals between the control unit and a user terminal. The control unit may include: a packet pattern information collection unit that operates the network connection unit in monitor mode to acquire the MAC addresses of surrounding Wi-Fi devices present in the monitored wireless network; an illegal device detection unit that compares the collected MAC addresses from the wireless LAN in monitor mode with the MAC addresses stored in the MAC list of the storage unit, detects unauthorized wireless devices, and, upon detection, notifies the user terminal of the detection through the wireless communication unit.

The control unit may further include: an illegal device blocking unit that transmits a de-authentication packet to the wireless network to block the unauthorized wireless device from connecting to the access point, thereby preventing data transmission from the illegal device.

The control unit may further include: an input/output control unit that, upon detection of an illegal device, transmits the illegal device information to the user terminal via the wireless communication unit, and upon receiving a command from the user terminal through the wireless communication unit, retrieves the MAC list from the user terminal and executes the blocking operation accordingly.

The control unit controls other units to pair with the user terminal via Bluetooth. Upon receiving an execution command from an application on the user terminal, the control unit instructs the appropriate units to provide various information about the apparatus to the user terminal. It also controls the reception of various lists—such as the MAC list, AP list, and firmware list—from the user terminal to perform the initial setup of the apparatus.

The control unit, upon receiving an operation command from the user via the application on the user terminal, may activate the network connection unit to enable the wireless LAN, check the firmware version and MAC list version from the version file on the user terminal, and, if a new firmware version or new MAC list version is detected, download the updated firmware data or MAC list data from the user terminal to update the firmware or MAC list. If the firmware data is updated, the control unit may perform a reboot, and then control the apparatus to proceed with the illegal device detection process.

The illegal device detection and blocking apparatus is configured as a portable device including a rechargeable battery. The wireless communication unit is configured to interoperate with the user terminal via Bluetooth communication, and the apparatus can be controlled through the user interface of the user terminal operated by the user.

### Advantageous Effects

According to an embodiment of the present invention, by using the illegal device detection and blocking apparatus to monitor a wireless internal network and detect unauthorized wireless signals, illegal devices can be blocked before any illegal activity occurs. The apparatus can also be applied to the security of various types of wireless communication networks.

According to an embodiment of the present invention, the illegal device detection and blocking apparatus can be carried by a general user and controlled in conjunction with a user terminal such as a smartphone. Accordingly, the apparatus can be conveniently activated at any time and place where the presence of an illegal device is suspected, allowing the user to easily detect and block illegal devices.

### BRIEF DESCRIPTION OF THE DRAWINGS

FIG. 1 is a block diagram of an illegal device detection and blocking apparatus according to an embodiment of the present invention;

FIG. 2 is a flowchart illustrating the operation method of the illegal device detection and blocking apparatus according to an embodiment of the present invention;

FIG. 3 is a schematic diagram showing a system including the illegal device detection and blocking apparatus according to an embodiment of the present invention;

FIG. 4 is a block diagram showing the configuration of the illegal device detection and blocking apparatus according to an embodiment of the present invention;

FIG. 5 is a diagram illustrating an example of illegal device operation in a network environment to which an embodiment of the present invention is applied;

FIG. 6 is a diagram for explaining the detection process of the illegal device detection and blocking apparatus according to an embodiment of the present invention;

FIG. 7 is a diagram for explaining the blocking process of the illegal device detection and blocking apparatus according to an embodiment of the present invention;

FIG. 8 is a flowchart illustrating the overall operation of the illegal device detection and blocking apparatus and the system including the same, according to an embodiment of the present invention.

### DETAILED DESCRIPTION

The present invention and technical problems solved by the present invention will become more apparent by the preferred embodiments of the present invention which will be described herein after. The following embodiments are only examples to explain the present invention, and are not intended to limit the scope of the present invention.

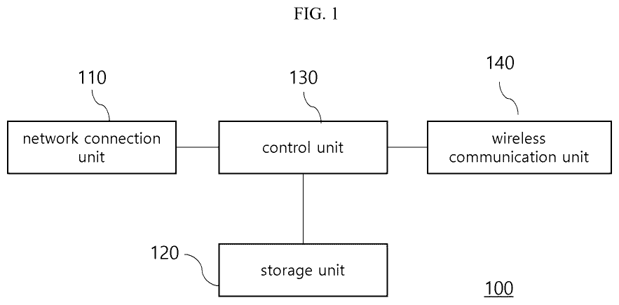

FIG. 1 is a block diagram of an illegal device detection and blocking apparatus according to an embodiment of the present invention.

As shown in FIG. 1, the illegal device detection and blocking apparatus 100 of the present invention comprises a network connection unit 110, a storage unit 120, a control unit 130, and a wireless communication unit 140.

Referring to FIGS. 1 to 3, the network connection unit 110 is configured to connect to a monitored network to acquire MAC addresses and, under control commands, block devices associated with specific MAC addresses. The storage unit 120 stores MAC addresses of illegal devices in the form of a MAC list. The illegal device detection and blocking apparatus 100 blocks illegal devices that have MAC addresses included in the MAC list. Accordingly, the MAC list functions as a block list for target devices. The wireless communication unit 140 receives signals from the control unit 130 and transmits them to the user terminal 200, and also delivers signals from the user terminal 200 to the control unit 130.

The user may carry the illegal device detection and blocking apparatus 100 together with a user terminal 200, such as a personal smartphone, and activate the apparatus 100 at a location suspected of containing an illegal device. The illegal device detection and blocking apparatus 100 may be configured without a dedicated user interface. The user terminal 200 can communicate with the apparatus 100 through a short-range communication method such as Bluetooth. Accordingly, the user can operate the illegal device detection and blocking apparatus 100 using an application on the user terminal 200.

The storage unit may be configured to include volatile memory such as RAM (Random Access Memory), non-volatile memory such as ROM (Read Only Memory), EPROM (Erasable Programmable ROM), EEPROM (Electrically Erasable Programmable ROM), flash memory, or any computer-readable recording medium well known in the technical field to which the present invention pertains.

The MAC list, when devices are managed using a blacklist and whitelist scheme, serves as a block list corresponding to the blacklist, in which MAC addresses of illegal devices are stored. This list can be configured during the manufacture of the illegal device detection and blocking apparatus of the present invention, and may be continuously updated by the user terminal 200.

The control unit 130 receives the MAC addresses of devices connected to the monitored network through the network connection unit 110, compares them with the MAC addresses stored in the MAC list of the storage unit 120 to detect illegal devices, and, upon detection, notifies the user terminal 200 via the wireless communication unit 140. After receiving a blocking command from the user terminal 200, the control unit blocks the transmission of the corresponding illegal device through the network connection unit 110. The control unit 130 may be configured to include a CPU (Central Processing Unit), MPU (Micro Processor Unit), MCU (Micro Controller Unit), GPU (Graphic Processing Unit), or any type of processor well known in the technical field of the present invention.

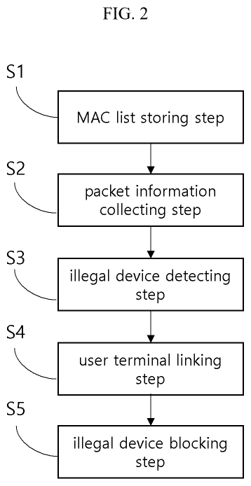

FIG. 2 is a flowchart illustrating the operation method of the illegal device detection and blocking apparatus according to an embodiment of the present invention.

Referring to FIG. 2, in the MAC list storing step S1, a “MAC list” presumed to correspond to illegal devices is obtained and stored in the storage unit 120.

In the packet information collecting step S2, the illegal device detection and blocking apparatus 100 collects packets present in the monitored network and extracts MAC addresses therefrom.

In the illegal device detecting step S3, the illegal device detection and blocking apparatus 100 compares the extracted MAC addresses with the MAC addresses stored in the MAC list to detect illegal devices.

In the user terminal linking step S4, the illegal device detection and blocking apparatus 100 transmits the detected illegal device information (e.g., MAC address, detection distance) to the user terminal 200 via short-range communication such as Bluetooth. The user terminal 200 then transmits an illegal device blocking command to the illegal device detection and blocking apparatus using the short-range communication.

In the illegal device blocking step S5, the illegal device detection and blocking apparatus 100 blocks the data transmission of the corresponding illegal device.

The apparatus and method of the present invention as described above may be implemented through the following specific embodiments.

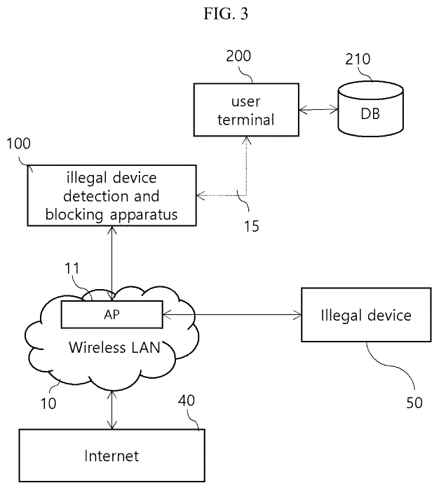

As shown in FIG. 3, the illegal device detection and blocking system according to an embodiment of the present invention may be configured to include: an illegal device detection and blocking apparatus 100, which is installed in a wireless LAN 10 environment, connected to a user terminal 200 via short-range communication 15, and configured to detect illegal devices present in the wireless LAN 10 and block their connections; and the user terminal 200, which controls the apparatus.

Referring to FIG. 3, the wireless LAN 10 is a wireless network operating in accordance with the IEEE 802.11 protocol, commonly referred to as Wi-Fi. Legitimate wireless terminals are connected to the wireless LAN, and a wireless illegal device 50, which is the target of monitoring in the present invention, may also be connected thereto.

The illegal device detection and blocking apparatus 100 is installed in the wireless LAN 10 environment and connected to the user terminal 200 via short-range communication 15. It detects illegal devices present in the wireless LAN 10, reports the detection results to the user terminal 200, and blocks the corresponding illegal device 50 according to a blocking command received from the user terminal 200. In the embodiment of the present invention, the illegal device 50 is a device recorded in the MAC list. The apparatus transmits the MAC address of the device to the user terminal 200 to request a determination, and if the device is identified as an illegal device and a blocking command is received, it proceeds to block the device.

The illegal device detection and blocking apparatus 100 monitors the illegal device 50 in monitor mode and blocks the illegal device 50 according to commands from the user terminal 200. Here, the monitor mode is a wireless LAN operating mode in which a Wi-Fi terminal, even if not connected to an access point (AP), can collect all wireless frames received through the antenna.

In addition, the illegal device detection and blocking apparatus 100 scans the network and transmits information such as the MAC addresses and detection distances of devices to the user terminal 200, enabling the information to be registered in the database 210.

The user terminal 200 includes a database 210, in which a version file storing the firmware (F/W) version of the illegal device detection and blocking apparatus 100 and the version information of the MAC list is stored. The database 210 may also store the MAC list and firmware (F/W) data.

The user terminal 200 may register various types of information from the illegal device detection and blocking apparatus 100 in the database 210. Specifically, the user terminal 200 may include functions such as displaying the retrieved MAC list, checking the MAC addresses of suspected devices and updating the MAC list by registering them upon blocking, and uploading version files, firmware files, and MAC list files.

The user terminal 200 may connect to an external server (not shown) via a mobile communication network to download files such as the MAC list file and firmware file. This external server may be operated by the company that sells the illegal device detection and blocking apparatus 100, or by a separate service provider. The company may also provide the application stored on the user terminal 200. The external server may register users who have installed the illegal device detection and blocking apparatus 100 as members, and provide features such as an administrator mode interface, member information management screen, and member device management screen. The retrieved MAC list may include information such as signal sensitivity, data volume, and suspicion status. Here, a “suspected device” refers to a device that is determined by the illegal device detection and blocking apparatus 100, according to a predetermined procedure, to be potentially illegal. The user terminal 200 can notify the user of the suspected devices reported by the illegal device detection and blocking apparatus 100 through the app, or notify the external server. Based on the user's instruction or the external server's instruction, if a suspected device is ultimately determined to be an illegal device, it can be registered in the MAC list and blocked accordingly.

The block list (MAC list) may be prepared on the external server by the company that sells the device detection and blocking apparatus 100 or by a separate service provider. These entities may identify and compile MAC addresses commonly used by manufacturers of illegal devices and provide them as a block list.

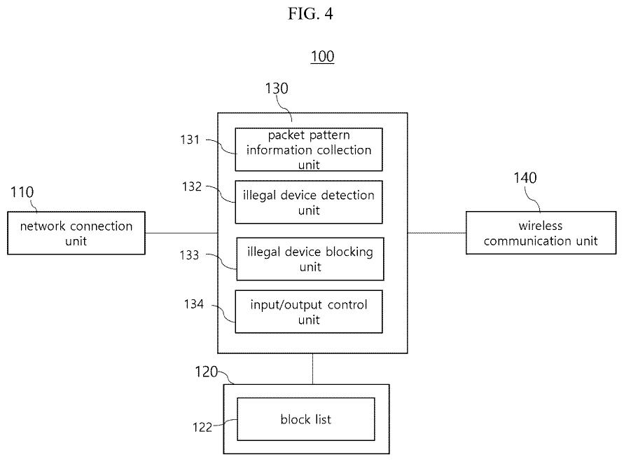

FIG. 4 is a block diagram showing the configuration of the illegal device detection and blocking apparatus according to an embodiment of the present invention.

As shown in FIG. 4, the illegal device detection and blocking apparatus 100 according to an embodiment of the present invention comprises a network connection unit 110; a control unit 130 including a packet pattern information collection unit 131, an illegal device detection unit 132, an illegal device blocking unit 133, and an input/output control unit 134; a storage unit 120 in which a MAC list 122 is stored; and a wireless communication unit 140.

Referring to FIG. 4, the network connection unit 110 is configured to connect to the monitored wireless LAN 10 and acquire the MAC addresses of devices present in the wireless network.

The packet pattern information collection unit 131 operates in monitor mode through the network connection unit 110 and collects MAC addresses of nearby Wi-Fi devices without being connected to an access point (AP). The illegal device detection unit 132 compares the MAC addresses collected in monitor mode from the wireless LAN with the MAC addresses registered in the MAC list 122 of the storage unit to detect wireless illegal devices 50.

The illegal device blocking unit 133, upon detection of a wireless illegal device 50 by the illegal device detection unit 132, transmits a de-authentication packet to block the operation of the wireless illegal device. Here, de-authentication refers to the process of blocking a device using management frames defined in IEEE 802.11, specifically disassociation frames (subtype: 1010) or de-authentication frames (subtype: 1100).

The input/output control unit 134 communicates with the user terminal 200 to perform operations such as updating the MAC list 122 stored in the storage unit 120 or updating the firmware. Specifically, when an illegal device 50 is detected, the input/output control unit 134 transmits the illegal device information to the user terminal 200 through the wireless communication unit 140, and processes commands received from the user terminal 200 via the wireless communication unit 140. For example, upon receiving a blocking command, it may retrieve the MAC list from the user terminal 200 and execute the blocking operation. Additionally, when a version file update command (for firmware version or MAC list version) is received, it receives the MAC list data or firmware data and updates them accordingly.

The wireless communication unit 140 serves as a communication means for communicating with the user terminal 200 and, in the embodiment of the present invention, may communicate with the user terminal 200 via short-range communication 15, such as Bluetooth.

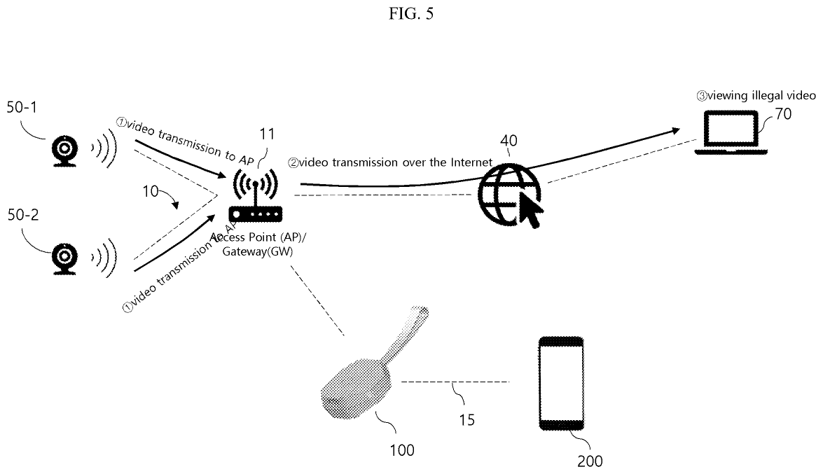

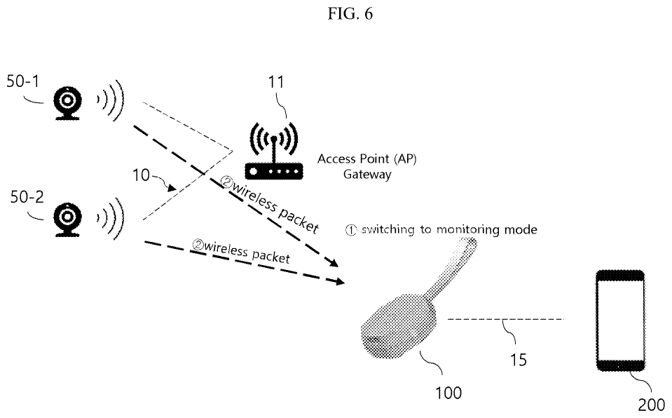

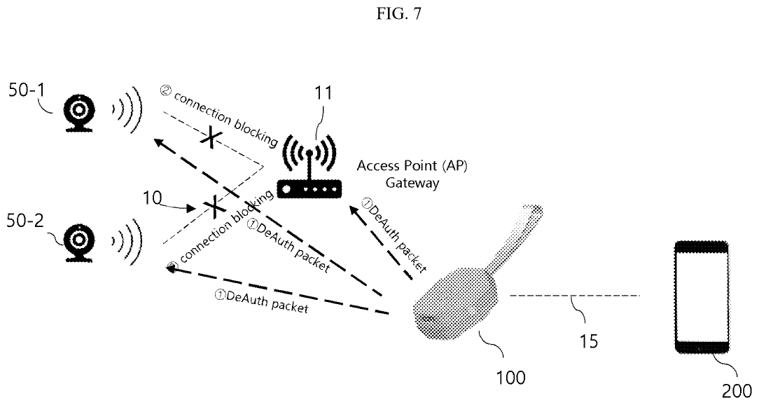

FIG. 5 is a diagram illustrating an example of the operation of an illegal device in a network environment to which an embodiment of the present invention is applied. FIG. 6 is a diagram for explaining the detection process of the illegal device detection and blocking apparatus according to an embodiment of the present invention. FIG. 7 is a diagram for explaining the blocking process of the illegal device detection and blocking apparatus according to an embodiment of the present invention.

As shown in FIG. 5, an example of a network environment to which an embodiment of the present invention is applied includes wireless illegal cameras 50-1 and 50-2 connected to the access point 11 via the wireless LAN 10. The illegal device detection and blocking apparatus 100 monitors the wireless network 10, while an illegal device viewing device 70 is connected through the Internet 40. The illegal device detection and blocking apparatus 100 is connected to the user terminal 200 via short-range communication 15.

In this state, when the illegal cameras operate, as illustrated in FIG. 5, the illegal footage captured by the wireless illegal cameras 50-1 and 50-2 is transmitted to the access point 11 via the wireless LAN 10. The footage sent to the AP 11 is then transmitted through the Internet 40 to the illegal video viewing device 70. As a result, the illegal video can be viewed on the viewing device 70.

Referring to FIG. 6, the illegal device detection and blocking apparatus 100 switches to monitoring mode, receives wireless packets from devices connected to the wireless LAN 10, extracts their MAC addresses, and compares them with the MAC addresses stored in the MAC list 122 to detect the wireless illegal cameras 50-1 and 50-2. When the wireless illegal cameras 50-1 and 50-2 are detected, as illustrated in FIG. 7, the apparatus transmits de-authentication packets to the wireless LAN 10 to block the wireless illegal cameras 50-1 and 50-2 from connecting to the access point 11.

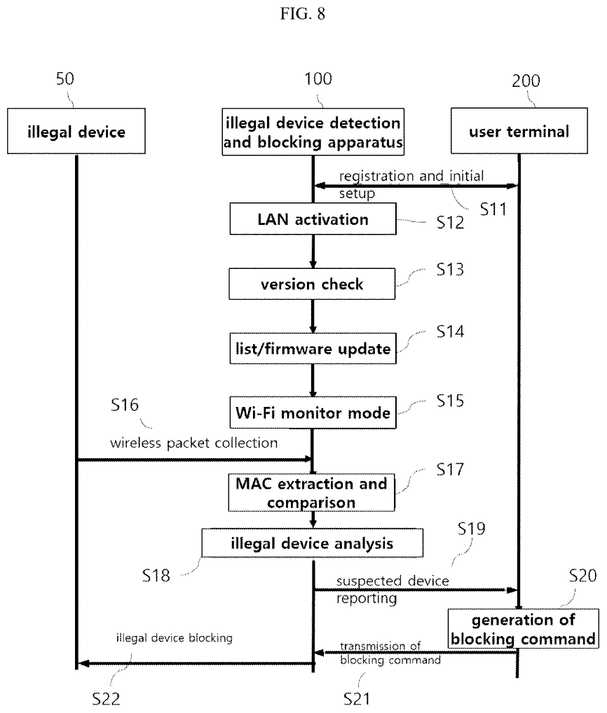

FIG. 8 is a flowchart illustrating the overall operation of the illegal device detection and blocking apparatus and the system including the same, according to an embodiment of the present invention.

When a user who has installed the illegal device detection and blocking apparatus 100 according to an embodiment of the present invention launches the application on the user terminal 200, the user terminal 200 pairs with the illegal device detection and blocking apparatus 100. The user terminal 200 receives various information about the apparatus 100 (such as the product serial number), and transmits various lists—such as the MAC list, AP list, and firmware list—to the illegal device detection and blocking apparatus 100 to perform the initial setup in step S11.

When an operation command or reset command is transmitted from the user terminal 200 to the illegal device detection and blocking apparatus 100, the apparatus 100 activates the wireless LAN by operating the network connection unit 110 in step S12.

Next, the firmware version and MAC list version are checked from the version file of the user terminal 200 in step S13.

If a new firmware version or a new MAC list version is detected, the illegal device detection and blocking apparatus 100 may download the updated firmware data or MAC list data from the user terminal 200 and update the firmware or MAC list accordingly in step S14. If the firmware data has been updated, the apparatus may perform a reboot to restart the entire process.

After confirming any updates to the MAC list or firmware version during the initial operation, the illegal device detection and blocking apparatus 100 operates in Wi-Fi monitor mode, receives wireless packets from devices connected to the wireless LAN 10, extracts MAC addresses, and compares them with those in the MAC list to detect wireless illegal devices. When a wireless illegal device is detected, the apparatus transmits the corresponding information to the user terminal 200 (S16 to S19). Upon receiving suspected device information from the illegal device detection and blocking apparatus 100, the user terminal 200 registers it in the MAC list and, according to a predefined procedure, transmits an illegal device blocking command to the apparatus. The illegal device detection and blocking apparatus 100, upon receiving the blocking command from the user terminal 200, transmits a de-authentication packet to the wireless LAN 10 to block the wireless illegal device (S20 to S22). More specifically, the illegal device detection and blocking apparatus 100, operating in monitor mode, captures MAC addresses on the wireless LAN, examines address 2 and address 3 of the MAC header to determine whether an illegal device is present, and, if detected, transmits the MAC address of the suspected device to the user terminal 200 via the mobile communication network 30.

Most general individuals carry a user terminal 200 such as a smartphone. By additionally carrying the illegal device detection and blocking apparatus 100, which is capable of interworking with the user terminal 200, it becomes possible to detect and block illegal devices 50. The illegal device detection and blocking apparatus 100 may be manufactured as a portable device in a handheld size. A loop-shaped strap may also be attached to one side of the apparatus to make it more convenient for the user to carry.

The user can turn the illegal device detection and blocking apparatus 100 on or off via an application installed on the user terminal 200, and may issue commands for the apparatus 100 to detect illegal devices. The user terminal 200 can display information about suspected devices received from the illegal device detection and blocking apparatus 100 to the user, and upon receiving a command from the user, transmit a blocking command to the illegal device detection and blocking apparatus 100.

In this embodiment, it is exemplified that the illegal device detection and blocking apparatus 100 does not include a user interface, and instead utilizes the interface of the user terminal 200 connected via short-range communication 15. However, it is also possible to provide a user interface by installing input/output means on the illegal device detection and blocking apparatus 100. Alternatively, the apparatus 100 may be configured to automatically execute all of the above processes without user intervention as soon as it is powered on, even without a user interface.

The present invention has been described above with reference to one embodiment illustrated in the drawings. However, it will be understood by those skilled in the art that various modifications and equivalent alternative embodiments may be made based on the above disclosure without departing from the scope of the invention.

1. An illegal device detection and blocking apparatus configured to detect and block illegal devices, such as hidden cameras, that may be installed on a pre-existing monitored network, comprising:
a network connection unit configured to connect to the wireless LAN of the monitored network;
a storage unit for storing a MAC list; and
a control unit configured to receive the MAC addresses of devices connected to the network through the network connection unit, and to block data transmission of illegal devices if an illegal MAC address is detected;
a wireless communication unit for transmitting and receiving signals between the control unit and a user terminal;
wherein the control unit includes:
a packet pattern information collection unit configured to acquire MAC addresses of nearby Wi-Fi devices present in the monitored wireless network, while the network connection unit is in monitor mode;
an illegal device detection unit configured to compare the MAC addresses collected in monitor mode from the wireless LAN with the MAC addresses stored in the MAC list of the storage unit to detect wireless illegal devices, and to transmit the detection result to the user terminal via the wireless communication unit when an illegal wireless device is detected.

2. The apparatus of claim 1,
wherein the control unit further comprises:
an illegal device blocking unit configured to transmit a de-authentication packet to the wireless network to block the wireless illegal device from connecting to an access point, thereby preventing data transmission from the illegal device.

3. The apparatus of claim 2,
wherein the control unit further comprises:
an input/output control unit configured to, upon detection of an illegal device, transmit information about the illegal device to the user terminal via the wireless communication unit, and, upon receiving a command from the user terminal through the wireless communication unit, retrieve the MAC list from the user terminal and perform the blocking operation.

4. The apparatus of claim 2,
wherein the control unit is configured to pair with the user terminal via Bluetooth, and upon receiving an execution command from an application on the user terminal, control the apparatus to provide various information about the apparatus to the user terminal,
and to receive various lists including a MAC list, an AP list, and a firmware list from the user terminal in order to perform initial setup of the apparatus.

5. The apparatus of claim 2,
wherein the control unit is configured to:
upon receiving an operation command from the user via an application on the user terminal, activate the wireless LAN by operating the network connection unit;
check the firmware version and MAC list version from a version file of the user terminal;
if a new firmware version or a new MAC list version is detected, download the updated firmware data or MAC list data from the user terminal to update the firmware or MAC list; and
if the firmware data is updated, perform a reboot and subsequently execute the illegal device detection process.

6. The apparatus of claim 1,
wherein the illegal device detection and blocking apparatus is configured as a portable device including a rechargeable battery,
the wireless communication unit is configured to interoperate with the user terminal via Bluetooth communication,
and the apparatus is controllable through a user interface of the user terminal operated by the user.
